(19) United States
(12) Patent Application Publication
(10) Pub. No.: US 2021/0387616 A1
(43) Pub. Date: Dec. 16, 2021

(54) IN-VEHICLE SENSOR SYSTEM

(71) Applicant: Toyota Jidosha Kabushiki Kaisha, Toyota-shi (JP)

(72) Inventor: Takumi Kobayashi, Susono-shi (JP)

(73) Assignee: Toyota Jidosha Kabushiki Kaisha, Toyota-shi (JP)

(21) Appl. No.: 17/328,245

(22) Filed: May 24, 2021

(30) Foreign Application Priority Data
Jun. 16, 2020 (JP) 2020-103715

(51) Int. Cl. B60W 30/095; G01S 13/931; G01S 13/42

(52) U.S. Cl. CPC B60W 30/0956; G01S 13/931; G01S 13/42; B60W 30/0953; B60W 2554/20; B60W 2420/52; B60W 2520/00; B60W 2554/4029; G01S 2013/9323

(57) ABSTRACT

A system of the present disclosure includes a coarse observation sensor configured to observe a range around a vehicle, high-accuracy observation object identification means configured to identify a high-accuracy observation object that is an object detected by the coarse observation sensor in the observation range and is an object to be observed at a higher resolution, object presence area prediction means configured to predict a range of an object future presence area where the high-accuracy observation object may be present after the identification, a fine observation sensor configured to observe the range of the object future presence area at the higher resolution, and object information output means configured to output information on the high-accuracy observation object observed by the fine observation sensor.

### CROSS-REFERENCE TO RELATED APPLICATION

This application claims priority to Japanese Patent Application No. 2020-103715 filed on Jun. 16, 2020, incorporated herein by reference in its entirety.

### BACKGROUND

### 1. Technical Field

The present disclosure relates to a device for detecting the situation around a vehicle such as an automobile, and more specifically to a system for observing the situation around the vehicle using sensors (camera, millimeter wave radar, lidar (laser radar) etc.) that are mounted on the vehicle for detecting persons, other vehicles, obstacles, and the like around the vehicle.

### 2. Description of Related Art

When driving assistance control or autonomous driving control is performed for a vehicle, it is necessary to recognize the situation around the vehicle (for example, the presence or absence and the positions of persons, other vehicles, obstacles, displays, etc.) In a vehicle that performs such control, a system (in-vehicle sensor system) is mounted that observes the situation around the vehicle using sensors that detect persons, other vehicles, obstacles, displays, etc. around the vehicle such as those described above. Examples of such in-vehicle sensor systems are as follows. Japanese Unexamined Patent Application Publication No. 2019-95339 (JP 2019-95339 A) discloses an object recognition device that recognizes objects around a vehicle based on the signals of an in-vehicle lidar. In the disclosed configuration of this object recognition device, the part representing an object and the part representing the background are identified from the time-series signal data, obtained by the lidar, using a neural network, etc. to increase the recognition accuracy of the object. Japanese Unexamined Patent Application Publication No. 2017-207348 (JP 2017-207348 A) discloses a configuration in which the type of an object detected by the signals obtained from a radar is identified using a database created in advance. In the disclosed configuration, the database is updated by storing the identification result of an object, captured by a camera device, to increase the identification accuracy of the type of an object detected by the radar. Japanese Unexamined Patent Application Publication No. 10-246778 (JP 10-246778 A) discloses a radar device that has the automatic detection tracking function. This automatic detection tracking function emits the search beam, determines a tracking object based on the detection result, and directs the tracking beam toward the tracking object to track the object. In the proposed configuration, a reduction in the resolution of the radar is minimized.

### SUMMARY

Meanwhile, to realize driving assistance or autonomous driving more appropriately or more accurately, it is preferable to more accurately detect the situation around a vehicle, that is, it is preferable to more accurately detect the information on the presence or absence of persons, other vehicles, obstacles, and displays, etc. around the vehicle and the information on their positions or motions (moving speed, moving direction) and their types. In regard to this point, when the situation around a vehicle is observed using the in-vehicle sensor systems described above, the time required for observation becomes longer as the observation accuracy, that is, the observation resolution, becomes higher. Therefore, an attempt to observe the situation around a vehicle widely and accurately requires a long time. In particular, when a vehicle is travelling, the observation is made while moving. This means that the time that can be spent on observing a particular range is limited and, therefore, it is sometime temporarily difficult to accurately observe the whole area of a range to be observed. To address this problem, the present applicants propose an in-vehicle sensor system (Japanese Patent Application No. 2020-71587.) This in-vehicle sensor system uses two sensors: a first sensor (coarse observation sensor) that detects the situation around a vehicle and a second sensor (fine observation sensor) that has an angular resolution higher than that of the first sensor. In the configuration of this in-vehicle sensor system, the situation around a vehicle is widely and quickly observed at a relatively low resolution by the coarse observation sensor. After that, by referring to the observation result of the coarse observation sensor, an area in which an object to be observed accurately (high-accuracy observation object) is included is identified in that observation range and, then, the identified area is observed at a high resolution by the fine observation sensor. According to this in-vehicle sensor system, the coarse observation sensor is used to quickly observe the wide range around the vehicle and, then, the fine observation sensor is used to observe a narrowed area including an object to be observed relatively accurately. This configuration makes it possible to obtain an accurate observation result for a particular area for which accurate information is desired while reducing the total observation time.

In the in-vehicle sensor system that observes the situation around a vehicle using the coarse observation sensor and the fine observation sensor as described above, the wide range around the vehicle is first observed by the coarse observation sensor and, in the observed range, an area including a high-accuracy observation object to be observed by the fine observation sensor is identified and, after that, the identified area is observed by the fine observation sensor. In that case, when the high-accuracy observation object or the vehicle itself moves from the time the observation by the coarse observation sensor is performed to the time the observation by the fine observation sensor is started, the high-accuracy observation object deviates from the area identified in the range observed by the coarse observation sensor and, as a result, the high-accuracy observation object cannot be observed by the fine observation sensor. Therefore, to allow the fine observation sensor to observe the high-accuracy observation object in the configuration of the in-vehicle sensor system described above even when the high-accuracy observation object or the vehicle itself has moved, it is necessary to predict an area where the high-accuracy observation object will be present at the time when the observation by the fine observation sensor is performed to allow the fine observation sensor to observe the high-accuracy observation object in the predicted area.

To address this problem, the present disclosure provides an in-vehicle sensor system in which the situation around a vehicle is observed in the manner as described below using the coarse observation sensor and the fine observation sensor. This in-vehicle sensor system has a configuration in which the wide range around the vehicle is observed by the coarse observation sensor, an object to be more accurately observed is identified in the observed range, and the identified object is observed by the fine observation sensor more accurately. In this configuration, even when an object to be observed more accurately and/or the vehicle has moved from the time the observation by the coarse observation sensor is performed to the time the observation by the fine observation sensor is performed, the in-vehicle sensor system allows the fine observation sensor to observe the object more reliably.

In addition, the present disclosure provides an in-vehicle sensor system that is configured as described above and is configured to predict the presence area of an object to be observed more accurately at the time of observation by the fine observation sensor to allow the fine observation sensor to observe the high-accuracy observation object in the predicted area.

One aspect of the present disclosure relates to an in-vehicle sensor system configured to observe the situation around a vehicle. The in-vehicle sensor system includes a first sensor, high-accuracy observation object identification means, object presence area prediction means, a second sensor, and object information output means. The first sensor is configured to observe a predetermined range around the vehicle at a first resolution. The high-accuracy observation object identification means is configured to identify a high-accuracy observation object. The high-accuracy observation object is an object detected by the first sensor in the predetermined range and is an object to be observed at a second resolution. The second resolution is higher than the first resolution. The object presence area prediction means is configured to predict a range of an object future presence area. The object future presence area is an area where the high-accuracy observation object may be present after the identification. The second sensor is configured to observe the range of the object future presence area at the second resolution. The object information output means is configured to output information on the high-accuracy observation object observed by the second sensor.

In the above configuration, “observing the situation around a vehicle” means detecting objects, such as objects or displays, that are present in the space around the vehicle. The “first sensor” and the “second sensor”, which are a camera, a millimeter-wave radar, a lidar, etc., may be a sensor that detects, optically or using electromagnetic waves, the presence or absence of an object, the area in which the object is present, and/or the type of the object (whether the object is a person, a vehicle, a stationary object on the road or on the roadside, a display, a sign or the like) (In this specification, an object, a display, a sign, or the like, detected by such a sensor, is collectively referred to as an “object”.) The “first sensor” is configured to scan or capture a predetermined range around the vehicle at a first resolution (angular resolution or spatial resolution), which may be freely set or selected, for detecting an object that is present in the scanned or captured range. The predetermined range observed by the first sensor may be a freely-set range such as the area in front of, to the right and left of, and/or behind, the vehicle. For example, the predetermined range may be a range in which monitoring is required for driving assistance control or autonomous driving control. The “second sensor” is also configured to scan or capture a certain spatial range for detecting an object present in the certain spatial range. A sensor used as the second sensor has the second resolution higher than the first resolution of the first sensor. Therefore, a sensor selected as the second sensor can detect the position, presence range, and type of an object more accurately than the first sensor. In the above configuration, an object identified by the “high-accuracy observation object identification means” is an object that is detected by observation by the first sensor and is to be observed more accurately by the second sensor at the second resolution so that the purpose of using the observation result in the in-vehicle sensor system can be satisfied. Such an object may be identified according to the standard or mode that is freely set as will be described later. The “first sensor” corresponds to the above-mentioned “coarse observation sensor”, and the “second sensor” corresponds to the above-mentioned “fine observation sensor”. The “high-accuracy observation object identification means”, “object presence area prediction means”, and “object information output means” may be implemented in any manner, for example, by the operation performed according to programs executed on a computer device.

According to the configuration of the system of the present disclosure, the system operation is performed basically in the same manner as in the sensor system described in the above-mentioned patent application (Japanese Patent Application No. 2020-71587.) That is, the situation around the vehicle is first observed by the first sensor at a certain resolution (first resolution.) After that, an object that is detected by the observation and is to be observed at a higher accuracy (referred to as a “high-accuracy observation object”) is observed in the area where the object is present using the second sensor at a higher resolution (second resolution) in order to acquire the more accurate information on the object such as the position (or change in the position), presence range, type, etc.) In such a configuration, when a high-accuracy observation object or the vehicle moves from the time the observation of the high-accuracy observation object is performed by the first sensor to the time the observation by the second sensor is started, the high-accuracy observation object moves from the presence position or range identified at the time of observation by the first sensor as described above. In this case, even if the observation by the second sensor is performed in the presence position or range of the high-accuracy observation object identified at the time of observation by the first sensor, the high-accuracy observation object cannot be observed. To address this problem, the system of the present disclosure provides the following configuration. That is, after the high-accuracy observation object identification means identifies a high-accuracy observation object, the object presence area prediction means predicts an area where the high-accuracy observation object is likely to be present (object future presence area), in other words, predicts the expected position of the high-accuracy observation object. In that object future presence area that has been predicted, the second sensor performs observation. This configuration allows the second sensor to perform observation in the range where the high-accuracy observation object is predicted to be present, making it possible to observe the high-accuracy observation object more reliably. As a result, higher accuracy information on the position (or change in position), presence range, type, etc. of the high-accuracy observation object can be acquired.

The first resolution used in the observation by the first sensor may be set appropriately. Since the purpose of observation by the first sensor is, for example, to detect an object around the vehicle that may affect the traveling of the vehicle, the first resolution may be set to such an extent that a wide range of observations around the vehicle can be performed quickly. The actual first resolution may be adjusted or selected appropriately by the system designer, manufacturer, coordinator, or user in consideration of the processing speed of the sensor, the assumed vehicle speed and turning speed, the range of the moving speed of an object, etc. On the other hand, the second resolution (higher than the first resolution) used in the observation by the second sensor may also be set appropriately. Since the purpose of observation by the second sensor is, for example, to observe an identified object accurately to such an extent that the requirements of the driving assistance control or autonomous driving control of the vehicle are satisfied, the second resolution may be adjusted or selected appropriately by the system designer, manufacturer, coordinator, or user in consideration of the assumed vehicle speed and turning speed, range of the moving speed of an object, etc. while considering the required accuracy.

In the configuration described above, the object future presence area, where observation by the second sensor will be performed, moves from the presence position or range of a high-accuracy observation object observed at the time of observation of the high-accuracy observation object in the predetermined range observed by the first sensor. This means that the object future presence area can be determined based on the presence position or range of the high-accuracy observation object at the time of observation of the high-accuracy observation object in the predetermined range. Therefore, in the system of the present disclosure, the high-accuracy observation object identification means and the object presence area prediction means may be configured considering the target future presence area. More specifically, the high-accuracy observation object identification means may be configured to detect the presence position or range of a high-accuracy observation object in the predetermined range observed by the first sensor. The object presence area prediction means may be configured to predict the position or range of the object future presence area seen from the vehicle based on the presence position or range of the high-accuracy observation object in the predetermined range. The object future presence area that is predicted may typically be an area where the high-accuracy observation object will be present after an elapse of time from when the observation by the first sensor is performed to the time the observation by the second sensor is started.

The position or range of the object future presence area seen from the vehicle may be predicted in various modes. For example, the moving distance or moving direction of a high-accuracy observation object in the future depends on the type of the high-accuracy observation object, that is, depends on whether the high-accuracy observation object is a person, a vehicle, a stationary object, or any other object. Therefore, by referring to the type of a high-accuracy observation object, it is possible to predict a range of the future expected position of the object future presence area. Thus, in one mode of the system of the present disclosure, the high-accuracy observation object identification means may be configured to further detect the type of a high-accuracy observation object. In addition, the object presence area prediction means may be configured to predict the position or range of the object future presence area seen from the vehicle, based on the position or range of the presence area of the high-accuracy observation object in the predetermined range and, in addition, based on the type of the detected high-accuracy observation object. More specifically, the size of the area in which the object may be present in the future depends on the type of the object. For example, the moving distance over time is shorter when the high-accuracy observation object is a person than when the high-accuracy observation object is a vehicle. Therefore, the object presence area prediction means may be configured to predict the object future presence area of different sizes depending on the type of a high-accuracy observation object. In such a configuration, it is expected that the position or range of the object future presence area can be predicted more accurately according to the type of a high-accuracy observation object.

In addition, the position or range of the object future presence area seen from the vehicle depends on the moving distance of the vehicle traveled from the time the observation by the first sensor is performed to the time the observation by the second sensor is performed and, in addition, on the turning angle (change in yaw angle.) The above-described moving distance traveled by the vehicle can be determined by the vehicle speed of the vehicle or by any method (for example, a method using GPS information.) The above-described turning angle of the vehicle can also be determined by the value that determines the turning angle (turning state value) such as the wheel rudder angle, steering angle, yaw rate, and/or yaw angular acceleration, or by any method (for example, a method using GPS information.) Therefore, in one mode of the system of the present disclosure, vehicle motion state acquisition means may be provided for acquiring the vehicle speed or the moving distance of the vehicle and/or the turning state value or the turning angle. In addition, the object presence area prediction means may be configured to predict the position or range of the object future presence area seen from the vehicle, either based on the position or range of the presence area of a high-accuracy observation object in the predetermined range and, in addition, on the moving distance and/or the turning angle of the vehicle, or based on the position or range of the presence area of a high-accuracy observation object in the predetermined range and on the type of the high-accuracy observation object and, in addition, on the moving distance and/or the turning angle of the vehicle. As a result, the position or range of the object future presence area is predicted by considering the moving distance and/or turning direction of the vehicle from the time the observation by the first sensor is performed to the time the observation by the second sensor is performed. Therefore, it is expected that the accuracy of the position or range of the object future presence area will be further improved.

In addition, in the system of the present disclosure described above, the relative speed and/or relative moving direction of an observed object seen from vehicle may be detected during observation by the first sensor. In such a case, using the relative speed or relative moving direction thus detected, it is possible to more accurately predict the position or range, seen from the vehicle, where an object identified as a high-accuracy observation object may be present in the future. Therefore, in the system of the present disclosure described above, when the high-accuracy observation object identification means is configured to further detect the relative speed and/or the relative moving direction of a high-accuracy observation object seen from the vehicle, the object presence area prediction means may be configured to predict the position or range of the object future presence area seen from the vehicle, based on the position or range of the presence area of the high-accuracy observation object in the predetermined range and, in addition, based on the detected relative speed and/or relative moving direction of the high-accuracy observation object. In addition, since the position of a high-accuracy observation object seen from the vehicle changes depending on the turning angle of the vehicle from the time the observation by the first sensor is performed to the time the observation by the second sensor is performed, vehicle motion state acquisition means may be provided for acquiring the turning state value or turning angle of the vehicle. In this case, the object presence area prediction means may be configured to predict the position or range of the object future presence area seen from the vehicle, based on the position or range of the presence area of the high-accuracy observation object in the predetermined range, based on the detected relative speed and/or relating moving direction of the high-accuracy observation object, and based on the turning angle of the vehicle.

Meanwhile, in the system of the present disclosure, whether an object should be identified as a high-accuracy observation object may be determined freely according to the use purpose of the observation result, as already mentioned. In particular, when the observation result is used for the driving assistance of the vehicle or for the traveling control of autonomous driving, the level of an impact that each object, detected by wide-range observation around the vehicle, has on the traveling of the vehicle is used as a criterion for determining whether the object is to be observed with high accuracy. Therefore, the high-accuracy observation object identification means of the system of the present disclosure may be configured to include detected-object threat level determination means to determine a high-accuracy observation object based on the threat level of each object. Here, the detected-object threat level determination means described above is means configured to determine the threat level (that is, the level of impact on the traveling of the vehicle) of an object detected in the predetermined range observed by the first sensor. In most cases, the higher the threat level of an object, the higher the need for high-precision observation. Therefore, in the configuration described above, the high-accuracy observation object identification means may be configured to select at least one object, determined in descending order of the threat level, as an accuracy observation object.

Thus, in the in-vehicle sensor system according to the present disclosure described above where the coarse observation sensor and the fine observation sensor are used for observing the range around a vehicle, it is expected that, even if a sensor detected object or the vehicle itself moves, an object that is identified in a wide range around the vehicle during observation by the coarse observation sensor and that is to be observed more accurately is observed by the fine observation sensor more reliably. In the system of the present disclosure, instead of observing everything around the vehicle accurately, high-accuracy observation objects are narrowed down to important or necessary objects considering the purpose of observation, with the result that it is expected that high-accuracy observation can be performed quickly and more reliably. Therefore, in driving assistance control or autonomous driving control of the vehicle, the system of the present disclosure may be advantageously used to quickly and efficiently recognize the situation around the vehicle.

Other purposes and advantages of the present disclosure become more apparent from the description of the embodiments described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram of a vehicle to which an embodiment of an in-vehicle sensor system according to the present disclosure is applied;

FIG. 1B is a block diagram showing the configuration of the system in one embodiment of the in-vehicle sensor system according to the present disclosure;

FIG. 2A is a flowchart showing the operation of the system during the observation of the situation around a vehicle in the in-vehicle sensor system in the embodiment when the expected position of a high-accuracy observation object is predicted based on the type;

FIG. 2B is a flowchart showing the operation of the system during the observation of the situation around a vehicle in the in-vehicle sensor system in the embodiment when the expected position of a high-accuracy observation object is predicted based on the relative speed between the high-accuracy observation object and the vehicle;

FIG. 3A to FIG. 3D are plan views each showing the positional relationship between an object observed by the in-vehicle sensor system in the embodiment and the vehicle and showing the processing for predicting a future presence area, which is an expected position, based on the type of a high-accuracy observation object and for determining an observation range to be observed by a fine observation sensor; and

FIG. 4A to FIG. 4D are plan views each showing the positional relationship between an object observed by the in-vehicle sensor system in the embodiment and the vehicle and showing the processing for predicting a future presence area, which is an expected position, based on the relative speed between a high-accuracy observation object and the vehicle and for determining an observation range to be observed by the fine observation sensor.

### DETAILED DESCRIPTION

### Configuration of In-Vehicle Sensor System

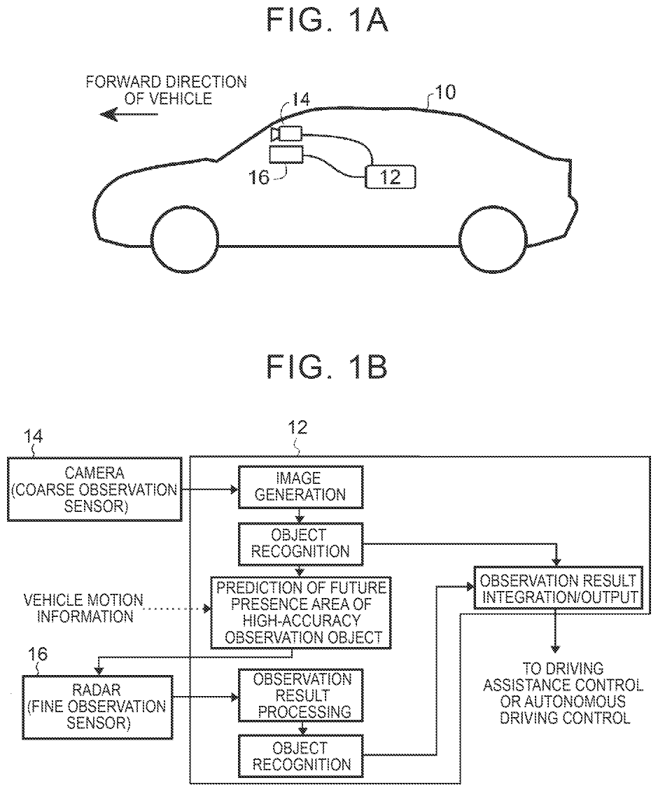

With reference to FIG. 1A, an embodiment of an in-vehicle sensor system of the present disclosure will be described. A vehicle 10 such as an automobile includes a coarse observation sensor 14, a fine observation sensor 16, and an observation control device 12. The coarse observation sensor 14 observes the situation around the vehicle 10 at a first resolution. The fine observation sensor 16 observes the situation around the vehicle 10 at a second resolution that is higher than the first resolution. The observation control device 12 controls the operation of the coarse observation sensor 14 and the fine observation sensor 16. In addition, the observation control device 12 receives signals from the coarse observation sensor 14 and the fine observation sensor 16 and, from the received signals, detects and recognizes the presence or absence of objects (such as other vehicles, roadside buildings, walls, fences, guardrails, poles, parked vehicles, pedestrians (pedestrians, bicycles) road ends, road markings (white lines, yellow lines,) and traffic lights), their positions or presence ranges, speeds, moving directions, or types, and outputs the result. The coarse observation sensor 14 may typically be a camera that captures the situation around the vehicle or may be a sensor, such as a millimeter wave radar or a lidar, that magnetically or optically scans and observes the situation around the vehicle. More specifically, as will be understood from the description below, the purpose of the coarse observation sensor 14 is to extensively and quickly observe the whole range, which is to be observed around the vehicle, for detecting the presence of an object that is around the vehicle and that may affect the traveling of the vehicle. Therefore, as the coarse observation sensor 14, a sensor is selected that need not to have a high resolution (see the note below) but that can observe the whole range, which is to be observed around the vehicle, as quickly as possible. On the other hand, the fine observation sensor 16 is typically a sensor, such as a millimeter wave radar (phased array radar, etc.) or a lidar, that magnetically or optically scans and observes the situation around the vehicle but may be a camera that captures the situation around the vehicle. As will be understood from the description below, the purpose of the fine observation sensor 16 to more accurately observe and recognize an object that is included in the objects detected by the coarse observation sensor 14 during the extensive observation around the vehicle and that is to be observed more in detail for use in driving assistance control or autonomous driving control. Therefore, as the fine observation sensor 16, a sensor is selected that, when observing a particular area or object, can observe the particular area or object at a resolution high enough to meet the purpose of the observation and recognition. The coarse observation sensor 14 and the fine observation sensor 16 for practical use may be appropriately selected according to the design of the vehicle, the cost, etc. Note that the visual field or the observation range of the coarse observation sensor 14 and the fine observation sensor 16 may be appropriately set so that the area in front of, to the sides of, and behind the vehicle can be observed.

(Note) The resolution of the coarse observation sensor 14 and the fine observation sensor 16 may be spatial resolution or angular resolution. The spatial resolution represents the minimum of the distance between two points at which the points can be distinguished in the space observed by the sensor. The angular resolution represents the minimum of the angle between two points at which the points can be distinguished in the visual field observed by the sensor. A high resolution means that the distinguishable distance or angle between two points is small.

The observation control device 12, which may be implemented by a computer, may include a computer or a driving circuit that has a CPU, a ROM, a RAM, and an input/output port device that are interconnected by a standard, bidirectional common bus. The configuration and the operation of each of the components of the observation control device 12, which will be described later, may be implemented by the operation of the computer that works according to a program.

Referring to FIG. 1B, and more specifically, the observation control device 12 may receive not only the observation data from the coarse observation sensor 14 and the fine observation sensor 16 but also the information indicating the vehicle motion state such as the vehicle speed (calculated from wheel speed, etc.), steering angle, yaw rate, etc. Alternatively, though not shown, the observation control device 12 may acquire the moving distance and the turning angle (change in yaw rate) of the vehicle from the GPS information (The information indicating the vehicle motion state, such as the vehicle speed, steering angle or yaw rate, moving distance, turning angle, etc. of the vehicle, is generically called “vehicle motion state information”). When the observation data (for example, brightness signal) from the coarse observation sensor 14 is received by the observation control device 12, its data format is first converted to a format in which the object in the observation range is recognizable, for example, converted to the image format (image generation unit). The observation range of data obtained at this time may be the whole range around the vehicle to be observed. After that, in the observation range of the data having the format such as the above-described image format, the object recognition unit detects and recognizes objects, with the result that there positions, presence ranges, types, speeds, and moving directions, etc. (seen from the vehicle) are detected at the resolution of the coarse observation sensor 14. After that, the high-accuracy observation object future presence area prediction unit determines a high-accuracy observation object (object to be observed more accurately) from among the detected objects in the manner that will be described later. Then, using the detection position, type, and the vehicle motion state information, the high-accuracy observation object future presence area prediction unit predicts the object future presence area, which is the expected area to which the high-accuracy observation object is expected to be present in the future (at the time when the high-accuracy observation object is observed by the fine observation sensor 16). Note that there may be a plurality of high-accuracy observation objects and a plurality of object future presence areas.

When the high-accuracy observation object and the object future presence area are determined as described above, the information is given to the fine observation sensor 16 so that the fine observation sensor 16 can observe the object at a higher resolution in the object future presence area. The observation data obtained during this observation (such as reflected-wave signal intensity) is sent to the observation result processing unit of the observation control device 12 and, in this unit, its data format is converted to the data format in which the object can be recognized. Then, the object recognition unit detects and recognizes the object in the object future presence area using the data format in which the object can be recognized, with the result that its position, presence range, type, speed, moving direction, etc. (seen from the vehicle) are detected at the resolution of the fine observation sensor 16.

In this way, the extensive information on the situation around the vehicle, detected and recognized by the coarse observation sensor 14, and the more accurate recognition information on a high-accuracy observation object, obtained during the observation by the fine observation sensor 16, are sent to the observation result integration/output unit. From that unit, the information on the situation around the vehicle and the information on the object may be sent to the corresponding control device so that the information will be used for driving assistance control and autonomous driving control. System Operation

(1) Overview

As mentioned in “Summary of the Disclosure”, when using the observation information on the situation around a vehicle for driving assistance control or autonomous driving control, it is preferable that the information on an object in the observed range, such as the position or presence range, type, speed, and moving direction, be detected and recognized with a higher accuracy. However, the higher the accuracy of the observation, the longer the time required for the observation. Therefore, it is sometime impossible to secure sufficient time for accurately observing the whole range to be observed around the vehicle, for example, while the vehicle is traveling. On the other hand, an object such as that used for driving assistance control or autonomous driving control, for which high-accuracy information is required, is present usually in a part of the range to be observed around the vehicle. This means that, once the approximate position of an object for which high-accuracy information is desired can be recognized, it is, in some cases, sufficient for high-accuracy observation to be performed only for the object for which such high-precision information is desired. Considering this fact, the observation is performed in the system in this embodiment as described in Japanese Patent Application No. 2020-71587. That is, in consideration of the speed of the motion of the vehicle, the observation of the whole observation range around the vehicle is performed quickly at a resolution high enough to obtain the information such as the presence/absence, position or presence range, type, speed, and moving direction of the objects in the observation range, while the observation at a high resolution is performed only for an object that need be observed with high accuracy. This reduces the whole observation time and, at the same time, gives high-accuracy information suitable for driving assistance control or autonomous driving control.

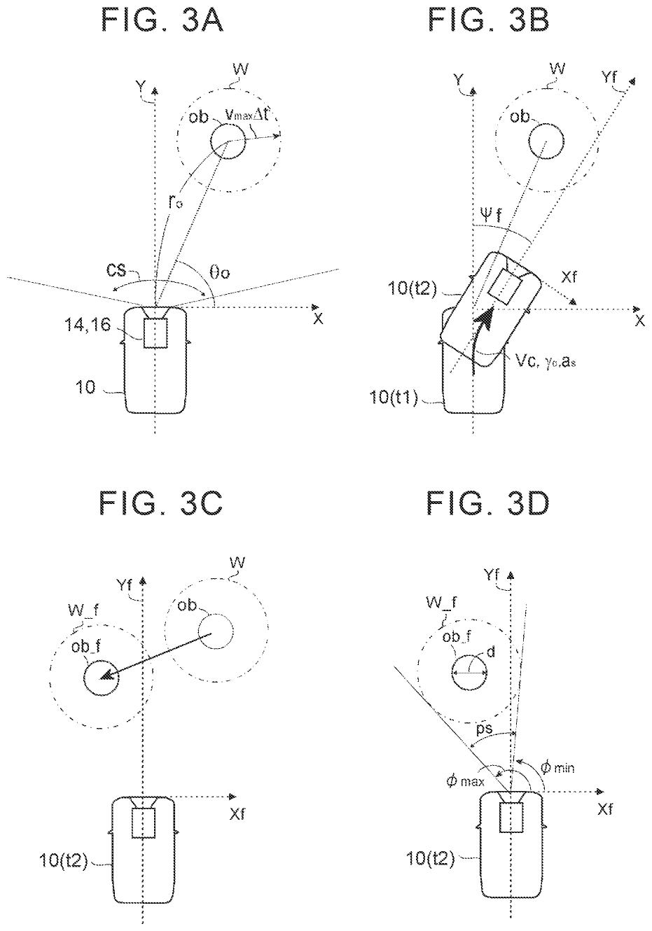

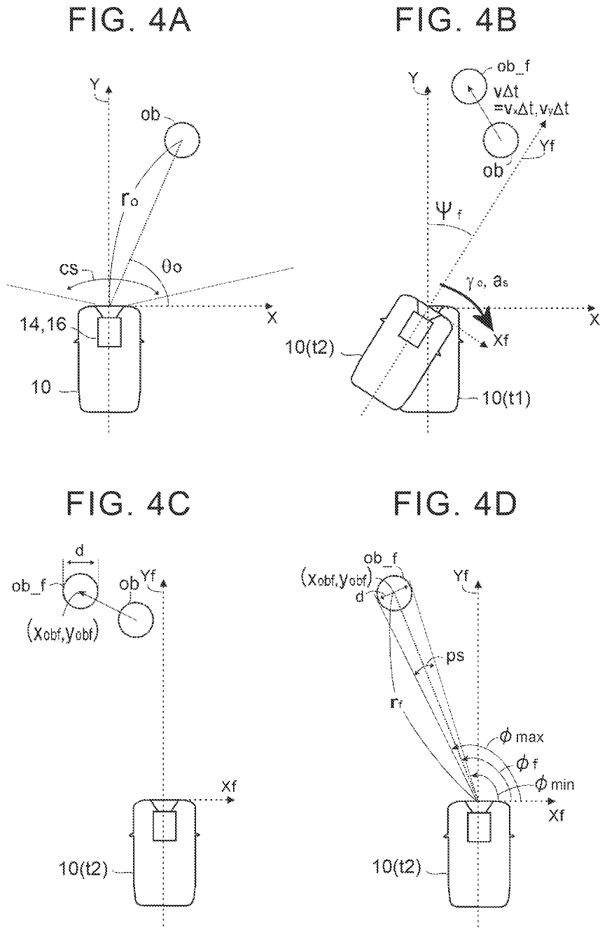

However, in the observation described above, it takes a certain amount of time from the time the observation of the whole observation range around the vehicle is performed using the coarse observation sensor to recognize the objects in the observation range and to identify a high-accuracy observation object to the time the observation using the fine observation sensor is started. During this period of time, the high-accuracy observation object or the vehicle may move to another position or change the direction. For example, as schematically shown in FIG. 3A to FIG. 3B and in FIG. 4A to FIG. 4B, the high-accuracy observation object (ob) moves from the position, seen from the vehicle 10 and identified in the observation range of the coarse observation sensor, to another position. In such a case, even if the observation by the fine observation sensor is performed at the position in the observation range identified by the coarse observation sensor, the high-accuracy observation object may not be performed (FIG. 3C, FIG. 4C). To address this problem, the system in this embodiment is configured to observe a high-accuracy observation object more reliably. That is, after the high-accuracy observation object is identified in the observation range identified by the coarse observation sensor, the expected position (object future presence area) of the high-accuracy observation object at the time the observation of the fine observation sensor is performed is predicted or estimated. Then, the observation by the fine observation sensor is performed in the predicted or estimated object future presence area.

(2) Operation of Observation Processing

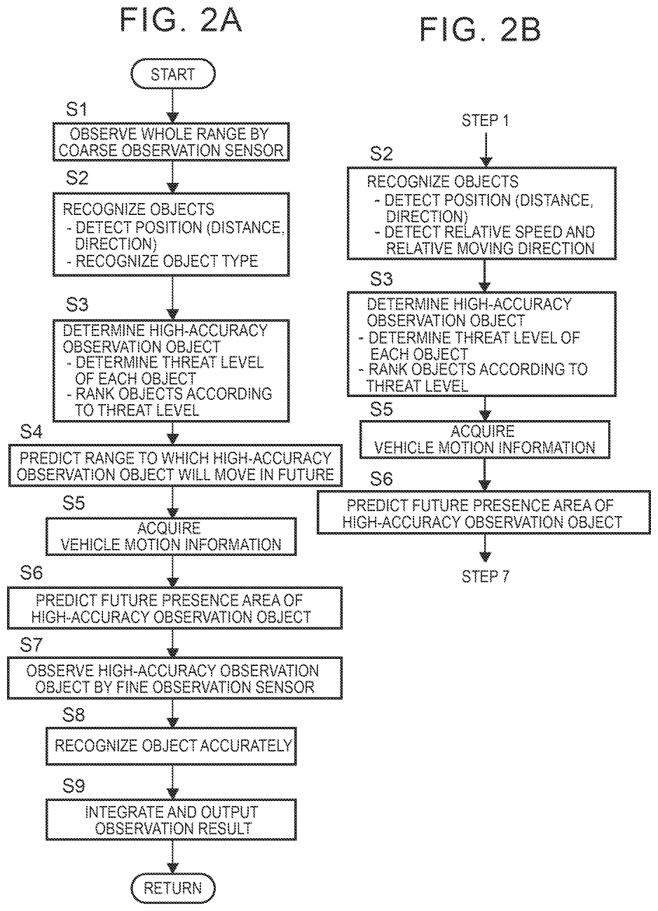

Referring to FIG. 2A and FIG. 2B, the general operation of the observation processing will be described. In the operation of the system in this embodiment, the following processing is performed sequentially:

(i) Observation of the whole observation range around the vehicle by the coarse observation sensor (step 1)
(ii) Recognition of objects in the observation range (step 2)
(iii) Determination of a high-accuracy observation object (step 3)
(iv) Prediction of the future presence area of the high-accuracy observation object (steps 4 to 6)
(v) Observation of the object future presence area by the fine observation sensor (step 7) (vi) Recognition of an object in the object future presence range (step 8)
(vii) Output of the observation result (step 9) The above processing will be described below sequentially.

(i) Observation of the Whole Observation Range Around the Vehicle by the Coarse Observation Sensor (Step 1)

As mentioned above, the observation by the coarse observation sensor may be typically performed by capturing an image by the camera in the usual manner as quickly as possible in the area to be observed around the vehicle (in front of, to the right and left of, and behind the vehicle, respectively). The resolution required in this case may be a resolution high enough to identify the presence or absence of objects in the observation range and to identify the positions or presence ranges of the objects at a certain degree of accuracy. The data obtained by the coarse observation sensor (usually brightness data or intensity data) may be generated as two-dimensional (or three-dimensional) image data by the image generation unit.

(ii) Recognition of Objects in the Observation Range (Step 2)

In the image data obtained by the image generation unit, the images of objects (such as other vehicles, roadside buildings, walls, fences, guardrails, poles, parked vehicles, pedestrians (pedestrians, bicycles), road ends, road markings (white lines, yellow lines), and traffic lights) are recognized, and the positions or presence ranges of those objects are detected (at the resolution of the coarse observation sensor). In addition, as will be described later, the type of an object described above or the moving speed and moving direction (seen from the vehicle) of an object may be detected in this step. A plurality of objects may be detected in the observation range. An object may be recognized and detected using any image recognition technique.

(iii) Determination of a High-Accuracy Observation Object (Step 3)

An object that is included in the objects recognized in the observation range of the coarse observation sensor in step 2 and is to be observed at a particularly high accuracy may be determined by any method according to the use purpose of the observation result. For example, when the observation result is used for driving assistance control for collision avoidance or is used for autonomous driving control, an object that will have a large impact on later driving may be selected as a high-accuracy observation object by referring to the distance from the vehicle to the object, the moving direction of the object, and the type of the object. In one mode, one possible method is that a threat level is given to each of the objects recognized in the observation range. In giving this threat level, it is assumed that the threat of an object to the traveling of the vehicle increases (the need for attention increases) as the distance to the vehicle is shorter, as the moving direction is more likely to intersect the traveling path of the vehicle, or as the moving speed is higher; alternatively, it is assumed that the threat increases in the order of a stationary object, another vehicle, and a person. After that, the threat levels of each object are totaled, the objects are ranked according to the threat level, and the high-accuracy observation objects to be observed preferentially are determined in the descending order of the rank. A plurality of objects may be selected as a high-accuracy observation object in a certain observation range.

(iv) Prediction of the Future Presence Area of the High-Accuracy Observation Object (Steps 4 to 6)

After a high-accuracy observation object is determined as described above, the expected position of the high-accuracy observation object in the future, more specifically, the expected position when observation is performed by the fine observation sensor (that is, the object future presence area) is predicted. The prediction of the object future presence area may be achieved in various ways, for example, as follows.

(a) Prediction of the Object Future Presence Area by Referring to the Type of the High-Accuracy Observation Object

In one mode, the object future presence area may be predicted according to the type of the high-accuracy observation object. In short, the movable range of the high-accuracy observation object from the observation position is calculated in this case based on the moving speed predicted according to the type of the high-accuracy observation object, and the calculated movable range is predicted as the object future presence area. In addition, the predicted position of the vehicle at the time when the observation is performed by the fine observation sensor may be calculated using the vehicle motion information, the object future presence area may be corrected to the position seen from the predicted position of the vehicle and, in addition, the angular range seen from the vehicle for observing the object future presence area may be determined.

More specifically, first, referring to FIG. 3A, when the object ob, recognized in the observation range cs of the coarse observation sensor 14, is determined in step 3 as a high-accuracy observation object, the center position X_{ob} of the high-accuracy observation object ob is determined as follows based on the distance rₒ (in the X-Y coordinate space fixed to the vehicle) and the direction θₒ (angle from the X axis) of the high-accuracy observation object ob seen from the vehicle 10:

X_{ob}=(rₒ cos θₒ,rₒ sin θₒ) (1)

Now, let Δt be the length of time from the coarse observation sensor observation time t1 to the fine observation sensor observation time t2 when the maximum moving speed vₘₐₓ assumed for the high-accuracy observation object ob is used. Then, the expected position of the high-accuracy observation object ob after an elapse of time Δt is on a circle with a radius of vₘₐₓ Δt and the center at the position X_{ob} or is the inside of the circle as shown in FIG. 3A. In this case, it is thought that the maximum moving speed vₘₐₓ of the high-accuracy observation object ob is determined according to the type of the high-accuracy observation object ob, that is, according what is the high-accuracy observation object ob (a person, a bicycle, an automobile, a motorcycle, etc.) For example, the maximum moving speed vₘₐₓ may be assumed as follows:

Person: 0 km/h (It is thought that a person hardly moves)

Bicycle: 20 km/h

Automobile: 100 km/h

Motorcycle: 80 km/h

Thus, the range to which the high-accuracy observation object ob will move in the future is predicted to be on or inside the following circle (step 4):

{(Y−rₒ cos θₒ)²+(X−rₒ sin θₒ)²}^{1/2}=vₘₐₓΔt (2)

That is, the object future presence range that varies in size depending on the type of the high-accuracy observation object may be predicted. When the motion of the vehicle 10 is not taken into consideration, this range to which the high-accuracy observation object ob will move in the future may be used as the object future presence area.

In addition, when the motion information on the vehicle 10 is acquired (step 5) and, based on the acquired motion information on the vehicle 10, the range to which the high-accuracy observation object ob, which has been predicted as described above, will move in the future is corrected, the accuracy of the object future presence area is improved. More specifically, when the vehicle 10 is moving, for example, at the vehicle speed V_{c}, initial yaw rate γₒ, and yaw angle acceleration a_{c} as shown in FIG. 3B, the yaw angle Ψ_{f} and the position X_{vf} (x_{vf}, y_{vf}) of the vehicle 10 at time t2 are expressed in the coordinates before the movement as follows:

Ψ_{f}=γₒΔt+a_{c}Δt²/2 (3a)

x_{vf}=∫V_{c}·cos Ψf(t)dt (3b)

y_{vf}=∫V_{c}·sin Ψf(t)dt (3c)

(The integration interval is [0, Δt].)

Here, the center position X_{obf} (x_{obf}, y_{obf}) of the high-accuracy observation object ob seen from the vehicle 10 at time t2 is expressed as follows by converting the coordinates from the X-Y coordinates to the Xf-Yf coordinates using expressions (3a) to (3c).

$$\begin{matrix}[ Expression 1 ] & \\ ( \begin{matrix}{x}_{o b f} \\ {y}_{o b f}\end{matrix} ) = ( \begin{matrix}cos {Ψ}_{f} & - s i n {Ψ}_{f} \\ sin {Ψ}_{f} & cos {Ψ}_{f}\end{matrix} ) ( ( \begin{matrix}{r}_{o} cos {θ}_{o} \\ {r}_{o} sin {θ}_{o}\end{matrix} ) - ( \begin{matrix}{x}_{v f} \\ {y}_{v f}\end{matrix} ) ) & ( 4 )\end{matrix}$$

Thus, the object future presence area of the high-accuracy observation object ob seen from the vehicle 10 after time tₒ is predicted to be on the following circle:

{(Y_{f}−y_{obf})²+(X_{f}−x_{obf})²}^{1/2}=vₘₐₓΔt (5)

That is, when the motion of the vehicle is taken into consideration, the object future presence area of the high-accuracy observation object ob seen from the vehicle 10 moves from the circle W, which is the presence area at the time of observation by the coarse observation sensor, to the circle W_f, as shown in FIG. 3C. This means that, when the motion of the vehicle is taken into consideration, the area on and inside the circle W_f is predicted as the object future presence area (step 6).

Thus, as shown in FIG. 3D, the range to be observed by the fine observation sensor 16 is the angular range ps in which the circle W_f can be viewed, with the angular range ps between angle φₘₐₓ and angle φₘᵢₙ when the Xf-Yf coordinates of the circle W_f are converted to the polar coordinates. The angular coordinates φ on the circle in expression (5) and the range of X_{f} are given by the following expression:

$$\begin{matrix}[ Expression 2 ] & \\ ϕ = {tan}^{- 1} ( \frac{{Y}_{f}}{{X}_{f}} ) = {tan}^{- 1} ( \frac{\pm \sqrt{{v}_{max}^{2} Δ {t}^{2} - {( {X}_{f} - {x}_{o b f} )}^{2}} + {y}_{o b f}}{{X}_{f}} ) \\ & ( 6 ) \\ {x}_{obf} - {v}_{max} Δ t ≦ {X}_{f} ≦ {x}_{obf} + {v}_{max} Δt & ( 6 a )\end{matrix}$$

Therefore, the angular range ps to be observed by the fine observation sensor 16 can be determined by calculating the maximum value φₘₐₓ and the minimum value φₘᵢₙ of the angular coordinates φ in expression (6) in the range indicated by the range (6a).

If the moving distance x_{vf}, y_{vf} or the turning angle Ψ_{f} of the vehicle during time Δt can be obtained in real time from the GPS information etc. when predicting the object future presence area as described above, those obtained values may be used in place of the calculations in expressions (3a) to (3c). In addition, if the turning angle Ψ_{f} during time Δt is negligible, the coordinate rotation calculation in expression (4) need not be performed. If vₘₐₓ=0, the object future presence area may be predicted as a range of the object size d.

(b) Prediction of the Object Future Presence Area Using the Speed of a High-Accuracy Observation Object

In another mode, when the speed and the moving direction of an object seen from the vehicle can be detected during the observation by the coarse observation sensor (when the relative speed in the x direction and the relative speed in the y direction of the object can be detected separately (step 2 in FIG. 2B)), the object future presence area may be predicted in consideration of the motion of the high-accuracy observation object and the motion of the vehicle. To put it briefly, in this case, based on the speed of the high-accuracy observation object (relative speed in the x direction and the relative speed in the y direction) and the turning angle of the vehicle in the coordinate space fixed to the vehicle 10 (obtained in step 5 in FIG. 2B), the expected position from that observation position is predicted as the object future presence area (step 6).

More specifically, when the object ob recognized in the observation range cs of the coarse observation sensor 14 is determined as a high-accuracy observation object as shown in FIG. 4A (as in (a)), the position X_{ob} of the high-accuracy observation object ob is determined from the distance rₒ and the direction θₒ (angle from the X axis) of the high-accuracy observation object ob seen from the vehicle 10 (in the X-Y coordinate space fixed to the vehicle) in the same way as in expression (1). Now assume that the high-accuracy observation object ob is moving relative to the vehicle 10 at the speed of v(vₓ, v_{y}). Then, as shown in FIG. 4B, during the period of time Δt from time t1 the observation by the coarse observation sensor is performed to time t2 the observation by the fine observation sensor is performed, the high-accuracy observation object ob moves by (vₓΔt, v_{y}Δt) from the position indicated in expression (1) (moves to the position of ob_f in the figure). During this period, if the vehicle 10 has turned at the initial yaw rate of γₒ and the yaw angular acceleration a_{c}, the yaw angle Ψf of the vehicle 10 at time t2 is given by expression (3a). Therefore, the position ob_f (x_{f}, y_{f}) of the high-accuracy observation object ob seen from the vehicle 10 at time t2 is expressed as follows by converting the position from the X-Y coordinates to the Xf-Yf coordinates using the yaw angle Ψ_{f}.

$$\begin{matrix}\{ Expression 3 ] & \\ ( \begin{matrix}{x}_{o b f} \\ {y}_{o b f}\end{matrix} ) = ( \begin{matrix}cos {Ψ}_{f} & - sin {Ψ}_{f} \\ sin {Ψ}_{f} & cos {Ψ}_{f}\end{matrix} ) ( \begin{matrix}{r}_{o} cos {θ}_{o} + {v}_{x} Δt \\ {r}_{o} sin {θ}_{o} + {y}_{y} Δt\end{matrix} ) & ( 7 )\end{matrix}$$

Thus, at observation time t2 of the fine observation sensor, the high-accuracy observation object ob will move to the position ob_f shown in FIG. 4C when seen from the vehicle 10. Therefore, the object future presence area of the high-accuracy observation object ob can be predicted as the range of the high-accuracy observation object ob having the size of d and centered on the position ob_f (x_{obf}, y_{obf}). As shown in FIG. 4D, the range to be actually observed by the fine observation sensor 16 is the angular range ps in which the side d of the high-accuracy observation object ob_f can be viewed. The angular range ps is a range from the angle φₘᵢₙ to yₘₐₓ when the Xf-Yf coordinates are converted to the polar coordinates. Here, the polar coordinates (r_{f}, φ_{f}) of the center position of the high-accuracy observation object ob_f are as follows:

r_{f}=(x_{obf}²+Y_{obf}²)^{1/2} (8a)

φ_{f}=tan⁻¹(y_{obf}/x_{obf}) (8b)

Therefore, the angular range ps to be observed by the fine observation sensor 16 is determined as a range between the following angles:

φₘᵢₙ=φ_{f}−tan¹(d/(2r_{f})) (9a)

φₘₐₓ=φ_{f}+tan⁻¹(d/(2r^{f})) (9b)

If the turning angle Ψ_{f} of the vehicle during time Δt can be obtained in real time from the GPS information etc. when predicting the object future presence area as described above, those obtained values may be used in place of the calculations in expression (3a). In addition, if the turning angle Ψ_{f} during time Δt is negligible, the coordinate rotation calculation in expression (7) need not be performed.

(v) Observation of the Object Future Presence Area by the Fine Observation Sensor (Step 7)

When the object future presence area is predicted and the angular range ps in which the predicted object future presence area can be viewed is determined as described above, the observation is performed by the fine observation sensor at an angle in the angular range ps. The resolution required in this step may be high enough for use as the information acceptable or satisfactory for driving assistance control or autonomous driving control.

(vi) Recognition of an Object in the Object Future Presence Range (Step 8)

The data obtained by the fine observation sensor (usually, intensity data or brightness data) may be sent to the observation result processing unit for converting it into a data format that allows the object to be recognized. After that, the object recognition unit recognizes the high-accuracy observation object based on the data obtained by the observation result processing unit. More specifically, the position or presence range and the type are identified, and the moving speed and the moving direction are detected, at an accuracy higher than that of the object obtained by the coarse observation sensor.

(vii) Output of the Observation Result (Step 9)

The information on the object recognized/detected through the observation by the coarse observation sensor and the fine observation sensor as described above may be integrated, as appropriate, and output to the corresponding control devices for use in driving assistance control and autonomous driving control.

Thus, as described in the above example, the system in this embodiment is an in-vehicle sensor system for observing the area around the vehicle using the coarse observation sensor and the fine observation sensor. This in-vehicle sensor system predicts the position, or the presence area, of an object to be observed by the fine observation sensor in consideration of the motion of the object to be detected by the sensor or the motion of the vehicle itself and performs observation by the fine observation sensor at the predicted position or in the predicted presence area. Therefore, it is expected that the observation of a high-accuracy observation object will be performed more reliably. The information on the area around the vehicle, acquired by the system in this embodiment, may be advantageously used in driving assistance control and autonomous driving control of the vehicle.

Although the above description has been made in connection with the embodiments of the present disclosure, many changes and modifications can be easily made by those skilled in the art. It is apparent that the present disclosure is not limited to the embodiments exemplified above but may be applied to various devices without departing from the concept of the present disclosure.

What is claimed is:

1. An in-vehicle sensor system configured to observe a situation around a vehicle, the in-vehicle sensor system comprising:
a first sensor configured to observe a predetermined range around the vehicle at a first resolution;
high-accuracy observation object identification means configured to identify a high-accuracy observation object, the high-accuracy observation object being an object detected by the first sensor in the predetermined range and being an object to be observed at a second resolution, the second resolution being higher than the first resolution;
object presence area prediction means configured to predict a range of an object future presence area, the object future presence area being an area where the high-accuracy observation object may be present after the identification;
a second sensor configured to observe the range of the object future presence area at the second resolution; and
object information output means configured to output information on the high-accuracy observation object observed by the second sensor.

2. The in-vehicle sensor system according to claim 1, wherein:
the high-accuracy observation object identification means is configured to detect a position or range of a presence area of the high-accuracy observation object in the predetermined range observed by the first sensor; and
the object presence area prediction means is configured to predict a position or range of the object future presence area seen from the vehicle, based on the position or range of the presence area of the high-accuracy observation object in the predetermined range.

3. The in-vehicle sensor system according to claim 2, wherein:
the high-accuracy observation object identification means is further configured to detect a type of the high-accuracy observation object; and
the object presence area prediction means is configured to predict the position or range of the object future presence area seen from the vehicle, based on the position or range of the presence area of the high-accuracy observation object in the predetermined range and, in addition, based on the detected type of the high-accuracy observation object.

4. The in-vehicle sensor system according to claim 2, the system further comprising vehicle motion state acquisition means configured to acquire a vehicle speed or moving distance, and/or a turning state value or turning angle, of the vehicle, wherein the object presence area prediction means is configured to predict the position or range of the object future presence area seen from the vehicle, based on the position or range of the presence area of the high-accuracy observation object in the predetermined range and, in addition, based on the vehicle speed or moving distance, and/or the turning state value or turning angle, of the vehicle.

5. The in-vehicle sensor system according to claim 3, wherein the object presence area prediction means is configured to predict the object future presence area that varies in size depending upon the type of the high-accuracy observation object.

6. The in-vehicle sensor system according to claim 2, wherein:
the high-accuracy observation object identification means is further configured to detect a relative speed and/or a relative moving direction of the high-accuracy observation object seen from the vehicle; and
the object presence area prediction means is configured to predict the position or range of the object future presence area seen from the vehicle, based on the position or range of the presence area of the high-accuracy observation object in the predetermined range and, in addition, based on the detected relative speed and/or detected relative moving direction of the high-accuracy observation object.

7. The in-vehicle sensor system according to claim 6, the system further comprising vehicle motion state acquisition means configured to acquire a turning state value or turning angle of the vehicle, wherein the object presence area prediction means is configured to predict the position or range of the object future presence area seen from the vehicle, based on the position or range of the presence area of the high-accuracy observation object in the predetermined range, based on the relative speed and/or relative moving direction of the high-accuracy observation object, and based on the turning state value or turning angle of the vehicle.

8. The in-vehicle sensor system according to claim 1, wherein the high-accuracy observation object identification means is configured to include detected-object threat level determination means to determine the high-accuracy observation object based on a threat level of an object, the detected-object threat level determination means being configured to determine the threat level of the object, the threat level representing a level of an impact of the object on traveling of the vehicle, the object being an object detected in the predetermined range observed by the first sensor.

9. The in-vehicle sensor system according to claim 8, wherein the high-accuracy observation object identification means is configured to select at least one object in descending order of the threat level as the high-accuracy observation object.

10. The in-vehicle sensor system according to claim 1, wherein the first and second sensors are sensors selected from a camera, a millimeter wave radar, and a rider.
